(19) United States
(12) Patent Application Publication
(10) Pub. No.: US 2005/0129450 A1
(43) Pub. Date: Jun. 16, 2005

(54) Process for obtaining a cosmetic pencil

(75) Inventor: Nadia Avalle, Vallese (CH)

Correspondence Address: AKERMAN SENTERFITT, P.O. BOX 3188, WEST PALM BEACH, FL, 33402-3188, US

(73) Assignee: Intercos S.p.A., Milano (IT)

(21) Appl. No.: 11/005,613

(22) Filed: Dec. 6, 2004

(30) Foreign Application Priority Data
Dec. 12, 2003 (IT) MI2003A002434

(51) Int. Cl. B43K 19/02

(52) U.S. Cl. 401/96

(57) ABSTRACT

The present invention refers to a process to obtain a pencil, in particular for cosmetic use, and to a pencil obtained with such procedure. In an embodiment thereof the process for obtaining a cosmetic pencil comprises the stages of: inserting a liquid or semi-liquid material into a container; inserting a cosmetic lead into said container; centering said lead inside of said container; waiting for the hardening of said liquid or semi-liquid material.

The present invention refers to a process to obtain a pencil in particular for cosmetic use, and to a pencil obtained with such procedure.

There are known pencils having inside of them a lead made up of cosmetic material to make up eyes, lips, eyebrows etc.

Normally, the external material of the pencil is made up of wood or other material which can be easily sharpened and which does not alter the cosmetic material. In traditional processes the material external to the pencil and made up of one or more pieces must previously be prepared by means of suitable moulds and/or workings, then it is assembled. Of course, it is necessary to pay attention to the dimensions and to the precise making of pieces being used, in order to obtain a finished product of good quality.

In view of the state of the art herein described, object of the present invention is to provide to a process for obtaining a pencil which is absolutely innovative as compared with the known art and which allows to obtain an aesthetically attractive pencil.

According to the present invention, such object is attained by means of a process for obtaining a cosmetic pencil, comprising the stages of: inserting a liquid or semi-liquid material into a container; inserting a cosmetic lead into said container; centering said lead inside said container; waiting for the hardening of said liquid or semi-liquid material.

Owing to the present invention, by incorporating the lead into a material which hardens and which makes up the covering of the pencil, an absolutely new process of construction is achieved, obtaining at the same time an aesthetically attractive and high quality pencil. The covering of the pencil, preferably transparent, allows to see the cosmetic product inside of it. In addition, it can be additioned with shining and/or coloring elements in order to make the object more attractive.

The characteristics and the advantages of the present invention will become evident from the following detailed description of an embodiment thereof, which is illustrated as a non limiting example in the enclosed drawings, in which:

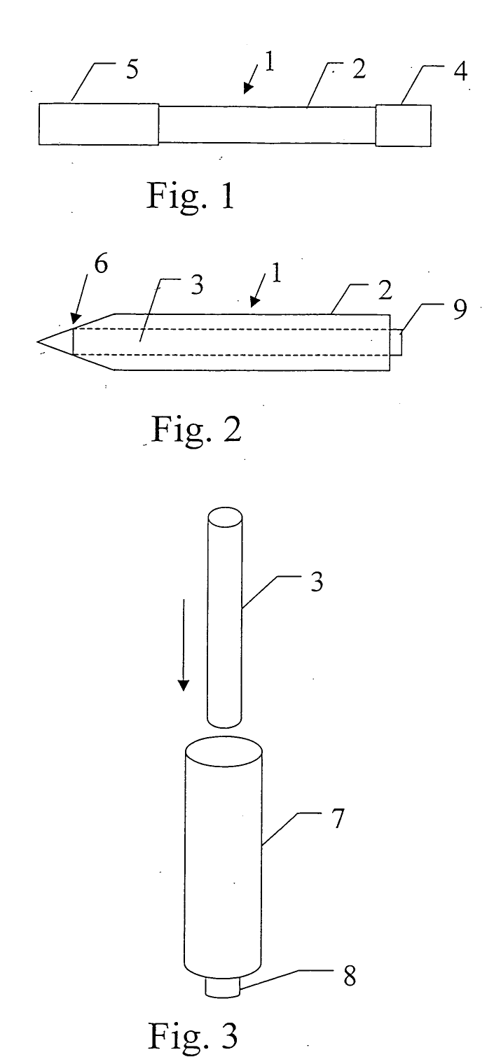

FIG. 1 shows a cosmetic pencil according to the present invention complete with cap and bottom;

FIG. 2 shows a cosmetic pencil according to the present invention;

FIG. 3 shows a mould for obtaining the pencil according to the present invention.

As shown in FIGS. 1 and 2, a cosmetic pencil 1 comprises a main body 2 (or covering of the pencil), having inside of it a cosmetic material 3. It can have a removable cap 5 in order to cover the tip 6 of the pencil after its use, and a bottom 4 in order to close the pencil 1 on the side opposite to the cap 5. The tip 6 of the pencil 1 is made sharp by sharpening it by means of a suitable pencil sharpener.

The shape of the cosmetic pencil 1, preferably cylindrical, can be for example of any other shape as oval, hexagonal, etc.

For the material of the main body 2 it is possible to use any material that is initially liquid or semi-liquid and which hardens in a reasonable time, for instance by application of heat or by reaction of several components and which, once hardened, is sharpenable. For example resins, plastic materials or waxes can be used.

As far as resins a bi-component epoxy resin with its hardener has been used (base component A and hardening component B), to which a third component is mixed (component C) again made up of an epoxy resin.

As an epoxy resin (component A) a resin, preferably transparent, has been favorably used which once hardened gets rigid, comprising Bisphenole A and/or Bisphenole F, and having a viscosity, at the liquid state, preferably of approximately 4000 mPas.

As hardener (component B) an aliphatic diamine has been utilised.

As third additive component (component C) an epoxy resin has been used, preferably transparent, which once hardened is elastic, with Bisphenole base and having a viscosity, at the liquid state, preferably of approximately 400 mPas.

The above resins have been utilised, for example, with the following proportions. Amount of the base component (component A) comprised between 25 and 45%, more preferably equal to 37.5%; amount of the hardener (component B) comprised between 15 and 35%, more preferably equal to 25%; amount of the additive component (component C) comprised between 25 and 45%, more preferably equal to 37.5%.

In addition to the above listed components it is possible to incorporate in the covering of the pencil 2 shining materials, such as pearls, glitter, and/or pigments of various nature, which can modify the aesthetic appearance.

The process of production of the pencils takes place, in an embodiment, by means of a mould 7, shown in FIG. 3, which reproduces exactly the shape of the finished product that one wishes to obtain. The mould 7 can be made up of any material which allows the material used as covering of the pencil 2 to easily come off from its walls and which allows an easy extraction of the finished piece, for instance it is possible to use bi-component, liquid silicone. In order to give a greater rigidity to the mould 7, this is placed, together with others, in a metallic support and contaiment structure (not shown).

In the aforesaid mould 7 the material used as covering 2 of the pencil is poured, in liquid or semi-liquid shape, then the cosmetic product (lead) 3 is inserted which can be any extruded, poured, pressed etc product for make-up. The lead 3 is then incorporated in the material used as covering 2 of the pencil.

The centering of the lead inside the mould 7 is carried out mechanically as for example by conformation of the mould 7 itself. The mould 7 has an inside diameter equal to the outside diameter of the pencil 1 with the exception of a terminal portion 8 which has a diameter equal to the diameter of the lead 3. In this way by pushing the lead, inside the material used as covering 2 of the pencil, up until the end of the mould 7, a part of it gets positioned in the terminal portion 8 which keeps it at the center of the mould 7.

As an alternative or in addition the centering of the lead can also take place by means of centering machines external to the mould (not shown).

At this point, once the perfect verticality of the lead is assured, the process involves a stage, of opportune duration, for the complete hardening of the material; such stage can be carried out either at room temperature or, in the case in which the lead allows it, also at higher temperatures in order to accelerate its hardening.

At the end of the previous operations the product is accurately extracted from the moulds and at this point it it is ready for finishing, which involves the sharpening of the tip 6, the possible elimination of the portion 9 of the lead 3 which projects from the element 2, the positioning of a bottom 4 and finally the positioning of a cap 5.

In an alternative embodiment, the mould 7 is replaced by a container. Once the hardening of the material used as covering 2 of the pencil, containing the lead 3, is completed the container used as a mould will be part of the pencil. The container must be made of a material that is capable to contain the material used as covering 2 of the pencil and must be sharpenable with the same pencil. It can be both transparent as well as coloured and it can contain shining elements. For example a transparent container has been used, having very thin walls, comprised between 0,05 and 1 mm, made of polycarbonate.

By sharpenable material a material is meant which by means of common pencil sharpener, with dimensions suitable for the dimension of the pencil, allows to sharpen the tip of the pencil normally without particular efforts. By the term liquid or semi-liquid material a substance is meant having a low viscosity so that an object can be inserted inside of it and therefore incorporated, without great difficulties and without ruining the object to be inserted as for example the lead of a cosmetic pencil.

1. Process for obtaining a cosmetic pencil comprising the stages of:
inserting a liquid or semi-liquid material into a container;
inserting a cosmetic lead into said container;
centering said lead inside of said container;
waiting for the hardening of said liquid or semi-liquid material.

2. Process according to claim 1, wherein said liquid or semi-liquid hardened material is sharpenable.

3. Process according to claim 1, wherein said liquid or semi-liquid material is transparent once hardened.

4. Process according to claim 1, wherein said liquid or semi-liquid material comprises pigments.

5. Process according to claim 1, wherein said liquid or semi-liquid material comprises shining elements.

6. Process according to claim 1, wherein said liquid or semi-liquid material comprises plastics.

7. Process according to claim 1, wherein said liquid or semi-liquid material comprises waxes.

8. Process according to claim 1, wherein said liquid or semi-liquid material it comprises epoxy resins.

9. Process according to claim 1, wherein said container is integral part of said cosmetic pencil.

10. Process according to claim 1, wherein said container is transparent.

11. Process according to claim 1, wherein said container is a mould and said process comprises in addition the stage of extracting said liquid or semi-liquid hardened material from said mould.

12. Cosmetic pencil obtained by the process of obtaining a cosmetic pencil comprising the stages of:
inserting a liquid or semi-liquid material into a container;
inserting a cosmetic lead into said container;
centering said lead inside of said container;
waiting for the hardening of said liquid or semi-liquid material.
